(19) United States
(12) Patent Application Publication
(10) Pub. No.: US 2013/0030893 A1
(43) Pub. Date: Jan. 31, 2013

(54) ONLINE SYSTEM FOR SHARING INFORMATION ABOUT ITEMS, PURCHASING PRODUCTS AND REWARDING PARTICIPANTS

(71) Applicant: Tamir Yaacobi, Tel Aviv (IL)

(72) Inventor: Tamir Yaacobi, Tel Aviv (IL)

(73) Assignee: Sharedise Group Limited, Nicosia (CY)

(21) Appl. No.: 13/495,410

(22) Filed: Jun. 13, 2012

Related U.S. Application Data
(60) Provisional application No. 61/497,747, filed on Jun. 16, 2011.

(51) Int. Cl. G06Q 30/02

(52) U.S. Cl. 705/14.16

(57) ABSTRACT

The system operates through a computer platform connected to an internet social network. A user can share information about an item through the network by providing it to the platform using a communications device connected to the network. If a similar or identical product corresponding to the item is available for purchase through the system, a link is created between the item and the product and the item is shared on the platform in digital media, such as an image of the item, selected by the sharing user. Other users can access the platform through the network using a communications device, view the image of the shared item, and purchase the available product. The sharing user is rewarded for sharing the item, regardless of whether or where the product is purchased. Both the sharing user and the purchasing user are rewarded if the product is purchased using the system.

### CROSS-REFERENCE TO RELATED APPLICATIONS

Priority is claimed on provisional patent application Ser. No. 61/497,747, filed Jun. 16, 2011.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to internet social networks and more particularly, to an online system accessed through an internet social network for sharing information about items, purchasing products and rewarding participants who utilize the system.

2. Description of Prior Art Including Information Disclosed Under 37 CFR 1.97 and 1.98

Social networks are today's main attraction on the internet. Internet users spend most of their time in social networking websites and applications. However, most of the time spent online in social networks provides no financial gain to the common user.

Various websites have developed commerce systems that allow users to browse and purchase products online. Most major online stores offer a mass of products with no personal relation to the potential buyer. However, unless the potential buyer has a solid idea of what he or she is looking for, the user will probably spend time visually searching through the stores sections and categories.

Often, people become exposed to products as they go through normal life activities that they may think they might want to purchase but have no way of doing so. For example: a person on her way back from work, while reading the newspaper on the subway, notices another woman wearing a beautiful shirt. She starts a conversation with the other women, inquiring where she purchased the shirt and learns that the same or a similar shirt is available for purchase at a particular store.

This ordinary event probably occurs many times every day. However, there is no system by which the woman interested in purchasing the shirt, or any other internet user that found the taste of the woman wearing the shirt interesting, could view all of the items in closet of the woman wearing the shirt and purchase the same or similar products, while that woman earns a reward on each purchase made, wherein the entire activity takes place using an internet social network.

The present invention is an online platform which permits users of an internet social network to gain financial advantage by sharing information about items with other users of the internet social network and which provides a way for those other internet social network users to purchase the same or similar products. Further, the present invention rewards users for sharing items, regardless of whether or where other users purchase the products, and rewards both the sharing user and the purchasing user, if the product is purchased using the system.

Sharing information about items is performed using digital media. Digital media may include any of the following: a digital image, digital video, visual media, digital text, digital books, RFID, Bluetooth device, Barcode and the like, or any combination thereof. The particular type of digital media to be used is selected by the user sharing the information. The selected digital media may be displayed on the system website and/or using a mobile application.

It is therefore, a prime object of the present invention to provide a system and method for using an internet social network as a potential source of financial gain.

It is another object of the present invention to provide an online system and method for sharing information about items, purchasing products and rewarding participants.

It is another object of the present invention to provide an online system and method for sharing information items, purchasing products and rewarding participants through the use of a computer platform to which users connect to through an internet social network.

It is another object of the present invention to provide an online system and method for sharing information items, purchasing products and rewarding participants, wherein users sharing information about an item are rewarded, regardless of whether or where the product is purchased by another user.

It is another object of the present invention to provide an online system and method for sharing information about items, purchasing products and rewarding participants, wherein users purchasing products about which information has been shared are rewarded, if the product is purchased through the system.

It is another object of the present invention to provide an online system and method for sharing information about items, purchasing products and rewarding participants, wherein users sharing information about an item, and users purchasing products about which information has been shared, are both rewarded, if the product is purchased through the system.

It is another object of the present invention to provide an online system and method for sharing information about items, purchasing products and rewarding participants, wherein the rewards include monetary awards.

It is another object of the present invention to provide an online system and method for sharing information about items, purchasing products and rewarding participants, wherein the rewards include ranking points which result in more extensive exposure of items shared by the rewarded user.

It is another object of the present invention to provide an online system and method for sharing information items, purchasing products and rewarding participants, wherein the computer platform stores information about item sharing and products purchased, causes purchased products to be shipped, and provides rewards to the participants when appropriate.

It is another object of the present invention to provide an online system and method for sharing information about items, purchasing products and rewarding participants, wherein the computer platform registers users, creates accounts for registered users, permits registered users to log into their account and to alter the personal information in their account.

It is another object of the present invention to provide an online system and method for sharing information about items, purchasing products and rewarding participants, wherein the user sharing information about an item selects the digital media to be used in the sharing of information.

It is another object of the present invention to provide an online system and method for sharing information about items, purchasing products and rewarding participants, wherein the information shared can include an image of the item.

It is another object of the present invention to provide an online system and method for sharing information about items, purchasing products and rewarding participants, wherein the information shared can include a video including an image of the item.

### BRIEF SUMMARY OF THE INVENTION

The above stated objects are achieved by the present invention which relates to an online system for use with an internet social network including a computer platform connected to the network. Means connected to the network are provided by which a first user can provide information about an item through the network to the platform. Means are provided for determining whether a similar or identical product corresponding to the item is available for purchase through the system. Means connected to the network are provided by which a second user may access the platform through the network, view the information provided by the first user and purchase the available product. Means are provided for rewarding the first user for providing information about an item. Means are also provided for rewarding the first user and the second user, if the second user purchases the product using the system.

Means connected to the platform are provided for storing information about products available for purchase.

The platform is operated by a platform provider. The platform provider causes the purchased product to be shipped to the second user.

The platform includes means for storing information with respect to system users, purchase orders, products available for purchase, and rewards. The platform also includes means for storing information about system activity.

The platform includes a website accessible by system users.

The platform includes means for sales and support personnel to communicate with system users.

The platform includes means for registering system users, for creating user accounts and for allowing registered users to log into the system. It includes means for allowing registered users to alter the personal information in their accounts and means for controlling access to the personal information in the registered user accounts.

The platform includes means for controlling the digital media in the system, means for allowing a registered user to select the digital media for display of information about an item, means for allowing a registered user to edit the selected digital media, and means for allowing a registered user to select and label certain regions within the selected digital media.

The platform includes means for storing information about products available for purchase and means for linking the information about products available for purchase and the information about an item provided by the first user.

The platform includes means for collecting and storing information relating to products available for purchase and the information provided by the first user about an item.

The platform includes means for controlling rewards provided to the first user and the second user. The rewards may include monetary awards.

The platform includes means for displaying the information about an item provided by the first user in an order determined by the number of ranking points possessed by the first user. The rewards may include ranking points.

The platform includes means for tracking activities for which users are entitled to be rewarded.

The platform includes means for controlling the distribution of rewards to users, including the timing of the distribution of the rewards.

The platform includes means for controlling orders for products received from the second user, including payments for the orders received from the second user.

The platform includes means for requesting and monitoring the status of the shipment of orders for products received from the second user.

The means connected to the network by which a first user can provide information about an item through the network to the platform comprise a mobile phone.

The means connected to the network by which a second user may access the platform through the network, view the information provided by the first user and purchase the available product comprise a mobile phone.

In accordance with another aspect of the present invention, an online method is provided which is performed using an Internet social network and a computer platform connected to the network. The method includes the steps of: providing information about an item to the platform through the network by a first user connected to the network; determining whether a similar or identical product corresponding to the item is available for purchase; accessing the platform through the network by a second user connected to the network to view the information provided by the first user and purchase the available product; rewarding the first user for providing the information to the platform; and rewarding the first user and the second user, if the second user purchases the product using the platform.

The method includes the step of storing information about products available for purchase.

The method includes the step of causing the purchased product to be shipped to the second user.

The method includes the step of storing information with respect to system users, purchase orders, products available for purchase, and rewards.

The method includes the step of storing information about system activity.

The method includes the step of accessing a website by system users.

The method includes the step of sales and support personnel communicating with system users.

The method includes the steps of registering system users, creating user accounts and allowing registered users to log into the system.

The method includes the step of allowing registered users to alter the personal information in their accounts.

The method includes the step of controlling access to the personal information in the register user accounts.

The method includes the step of controlling the digital media in the system.

The method includes the steps of allowing a registered user to select the digital media for display of the item, allowing a registered user to edit the selected digital media, and allowing a registered user to select and label certain regions within the selected digital media.

The method includes the steps of storing information about products available for purchase and linking products available for purchase and the item about which information was provided by the first user.

The method includes the steps of collecting and storing information relating to products available for purchase and the item about which information was provided by the first user.

The method includes the step of controlling the rewards provided to the first user and the second user, including providing rewards in the form of monetary awards.

The method includes the steps of providing rewards in the form of ranking points and displaying the information provided by the first user about the item in an order determined by the number of ranking points possessed by the first user.

The method includes the steps of tracking activities for which users are entitled to be rewarded, the distribution of rewards to users and the timing of the distribution of rewards to users.

The method includes the step of controlling orders for products received from the second user and payments for orders for products received from the second user.

The method includes the steps of requesting and monitoring the status of shipment of orders for products received from the second user.

The step of providing information about an item to the platform through the network by a first user connected to the network includes providing information about an item to the platform through the network by a first user connected to the network using a mobile phone.

The step of accessing the platform through the network by a second user connected to the network to view the information about the item provided by the first user includes accessing the platform through the network by a second user connected to the network to view the information about the item provided by the first user using a mobile phone.

### BRIEF DESCRIPTION OF THE DRAWINGS

FIG. 1 is a diagram illustrating the basic architecture of the system of the present invention and the connections between the computer platform that operates the system and the users of the system who connect to the platform through an internet social network using communications devices;

FIG. 2 is a block diagram showing the modular components of the computer platform;

FIG. 3 is a block diagram showing the components of the Members module;

FIG. 4 is a block diagram showing the components of the Media module;

FIG. 5 is a block diagram showing the components of the Catalog module;

FIG. 6 is a block diagram showing the components of the Rewards module;

FIG. 7 is a block diagram of the Orders module;

FIG. 8 is a flow diagram of core steps in the method of the present invention;

FIG. 9 illustrates the Logic Connector Component of FIG. 5.

### DETAILED DESCRIPTION OF THE INVENTION

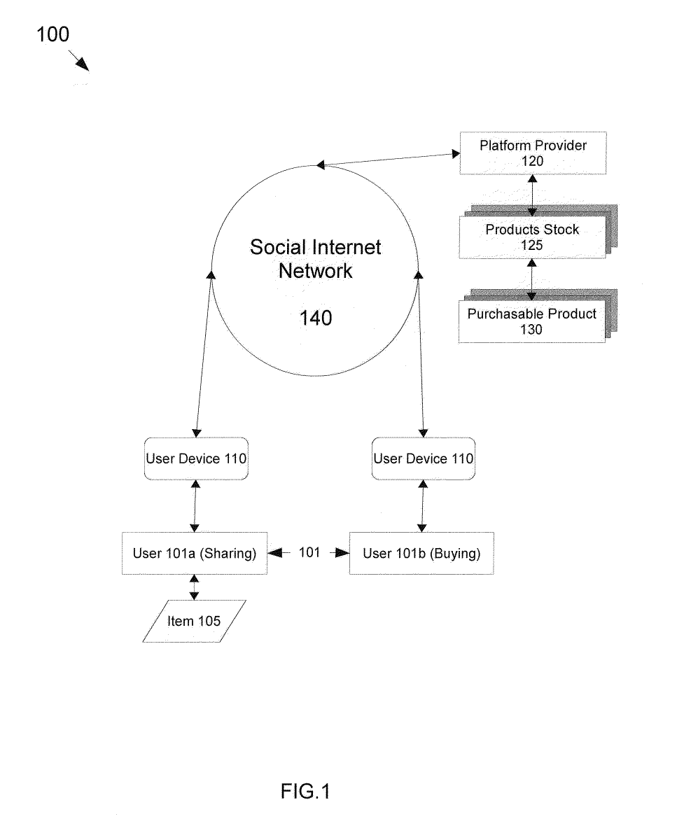

FIG. 1 illustrates the system 100 of the present invention. As seen in this figure, one or more users 101, through their user communications devices 110, are coupled to a computer platform provider 120 through an internet social network 140. Network 140 may include a local area network (LAN), a wide area network (WAN), a wireless network, an intranet, an internet, and/or the like. The user communications devices 110 may include a computer terminal, a personal digital assistant (PDA), a wireless telephone, a digital camera, web service, and/or the like.

The platform provider 120 provides the social networking services, communication services, company intranets, online stores, and so forth. For this example, the platform provider 120 may host a website that allows one or more users 101, (e.g. the item sharing user 101a and the potential buyer 101b, using one or more communications devices 110) to browse the website, share items 105, view items 105 shared by other users 101 and purchase a similar or identical product 130.

User 101 includes all users 101a interested in sharing information about an item through the system (“sharing users”) and all users 101b interested in purchasing a product the same as or similar to the item about which a user 101a has shared information on the system (“purchasing users”). User 101a shares information about an item 105 through network 140 by adding information about item 105 to the account of user 101a in the system. After the information is uploaded by the sharing user, the platform provider 120 will determine if a product or products 130 corresponding to that item is available for purchase through the system. If it is, the platform provider will create a link between the shared item 105 and the product 130 available for purchase through the system.

The information about item 105 provided to the system by user 101a is displayed as digital media through network 140. For example, a digital image of the item may be displayed. Digital media, as that term is used herein, may also include digital video, digital audio, visual media, digital text, digital books, RFID, Bluetooth device, Barcode and the like. However, for purposes of illustration, the digital media referred to in this example will include a digital image of the product. A user 101b visiting network 140 may be interested in purchasing a similar or identical product corresponding to the item 105 about which user 101a has shared on network 140. The system has two types of users: individuals and commercial entities.

The system 100 further includes one or more suppliers 125 which deliver purchased products. A supplier may be a company holding a drop shipping agreement with the platform provider 120 and/or a company holding an affiliate agreement with the platform provider 120 and/or the platform provider 120 itself holding a physical products stock available for purchase or the like. A supplier is a commercial entity that sells products. A user 101b that would like to purchase a product 130 (after viewing a shared item 105 of another user 101a through network 140) will complete his or her order with the Platform Provider 120 and/or the supplier 125. The supplier 125 will than deliver the purchased product 130 to the user 101b.

A user 101b visiting network 140 may be interested in purchasing the item 105 that user 101a has shared on network 140. If so, the present invention provides that user with a way to do so quickly and easily, as explained below. Once a user 101b purchases a product 130 (after viewing a shared item 105 of another user 101a through network 140), the platform provider 120 will cause the purchased product 130 to be shipped to the purchaser.

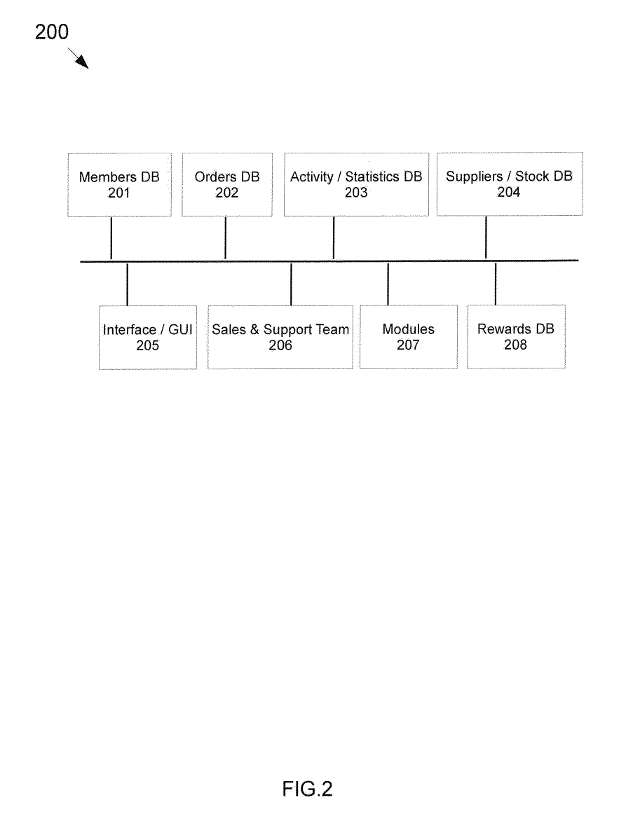

FIG. 2 shows the platform provider system components. The platform provider 120 may include a Members database 201, an Orders database 202, an Activity/statistics database 203, a Suppliers/products Stock database 204, a display interface 205, a sales & support team 206, Modules 207 (described below) and a Rewards database 208.

The Members database 201 stores all data associated with users 101. This data includes profile information for each user 101 and all the information about each item 105 shared by that user.

The Orders database 202 stores data associated with each purchase of a product 130 made through the system. This data includes the total price paid, shipping prices, a list of all products purchased, any correspondence between the customer and the platform provider and the like.

The Activity/statistics database 203 stores data relating to any activity made in the system. This data includes purchases made, shared information about items, accounts opened, rewards granted and the like.

The Suppliers/stock database 204 stores data associated with all products 130 available for purchase. This data includes product names, prices, descriptions, shipping methods, stock management and the like.

The Interface/GUI 205 for this example is the actual website where users visit, share items, make purchases and/or take any other action through a user device 110. Users can interact with the platform provider via the interface/GUI 205. The interface could be a webs ite, web service, application, automatic (such as images/bar-code/RFID scanner), human representative and/or the like.

The Sales & Support Team 206 handle any correspondence between a user 101 that makes a purchase or shares an item and the company that ships the item. They handle all matters in regard to actually providing the product 105 to the user 101. The team also provides users with support of any kind.

The Rewards Database 208 controls and stores data associated with rewards. This data includes the rewards name, and determines which actions (from the Activity/statistics database 203) are to be rewarded. It controls whether a reward is granted, the type of reward which is granted and when the reward should be granted.

Modules 207 include a set of components and code scripts that interact with all components of the system, thus connecting between all databases, the GUI, the support team and the users in the system. The modules are used to conduct the actual actions in the system such as: system sign-ups, editing account settings, checkout procedures, displaying items and products in the GUI, providing rewards to users and the like.

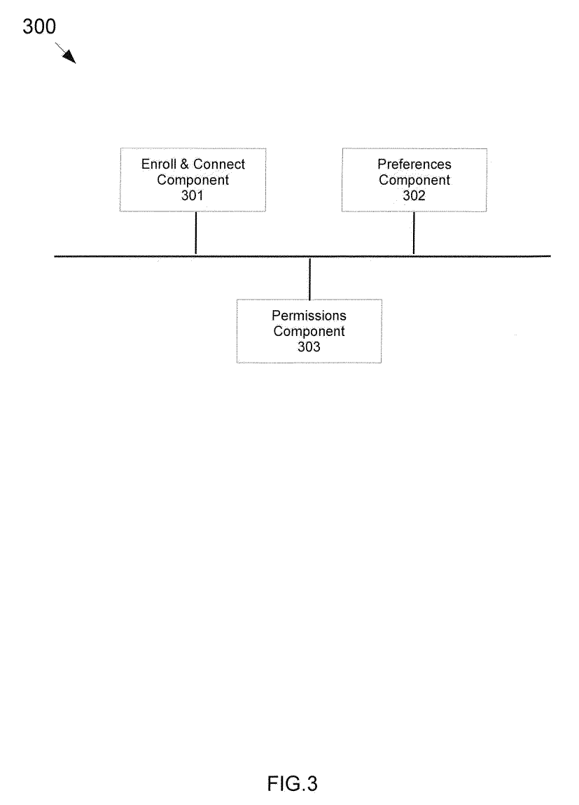

FIGS. 3 through 7 illustrate the components which form Modules 207.

FIG. 3 shows the components of the Members module 300. Members module 300 controls all actions relevant to members (e.g. users 101) in the system. Members module consists of various components that connect between users 101 and the Members database 201. The Members module includes an Enroll & Connect component 301, a Preferences component 302 and a Permissions component 303.

The Enroll & Connect component 301 allows users to register with the system, to create a personal account, then to login to their personal account. When creating a new account, all data is stored in the Members database 201 and the registration activity is logged in the Activity/Statistics database 203.

The Preferences component 302 allows users to edit the personal information in their account, such as the users name, email address, password, shipping address, method of receiving rewards, privacy settings and the like. All data received from the user 101 is stored in the Members database 201 and the activity is logged in the Activity/Statistics database 203.

The Permissions component 303 sets and manages users 101 permissions in the system. A user 101 has access to change his or her personal information. However, the user may not view personal information of other users 101 such as email address, purchases made, rewards received and the like. Those sorts of security procedures are controlled by Permissions component 303.

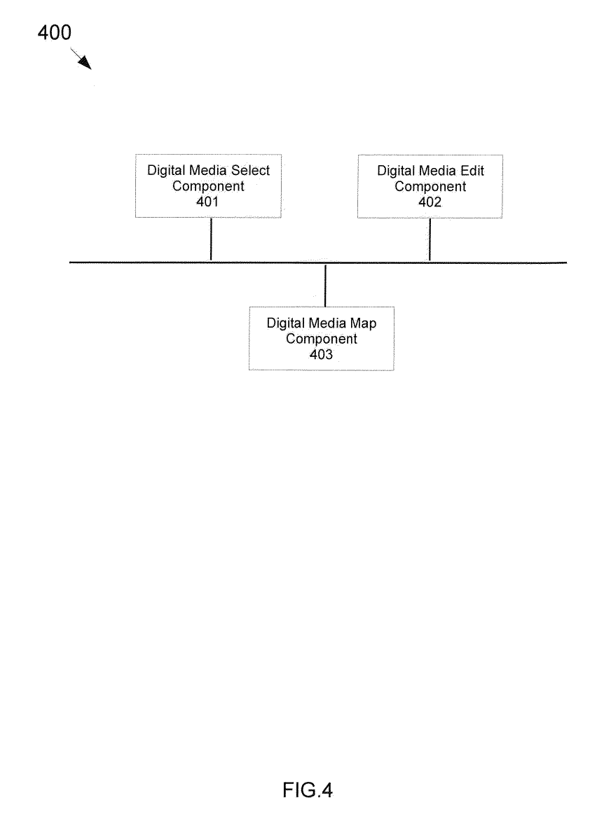

FIG. 4 shows Digital Media module 400. Digital Media module 400 controls all actions relevant to digital media in the system. Digital Media module 400 consists of various components that control the digital media in the system. The Digital Media module 400 includes a Digital Media select component 401, a Digital Media edit component 402 and a Digital Media Map Component 403.

Digital Media select component 401 allows user 101a to select a digital media in which an item to be shared is displayed. When a user 101a would like to add an item 105 to the system for sharing, a digital media is selected by the user. For this example, the selected digital media is an image of the item. The user 101a may select and upload the image from his or her communications device 110 (e.g. a personal computer) or select an existing image from the system. The digital media is stored in the Members database 201 and the activity is logged in the Activity/Statistics database 203.

The Digital Media edit component 402 allows user 101a to edit digital media. For example, resize an image, select segments in a video file or crop an image to a certain size. The digital media is stored in the Members database 201 and the activity is logged in the Activity/Statistics database 203.

The Digital Media Map Component 403 allows users 101 to select certain regions inside a digital media where the target item 105 is displayed. For example: a user 101a selects an image in which he or she is wearing the item consisting of a jacket and trousers. The user may select a certain region in the image and map it as a “jacket” item 105, than select a different region of the image and map it as a “trousers” item 105, thus mapping an image for particular items displayed in the image. The Regions map is stored in the Members database 201 and the activity is logged in the Activity/Statistics database 203. A user 101a may select only one region on the entire digital media and is not obligated to select various regions inside each digital media.

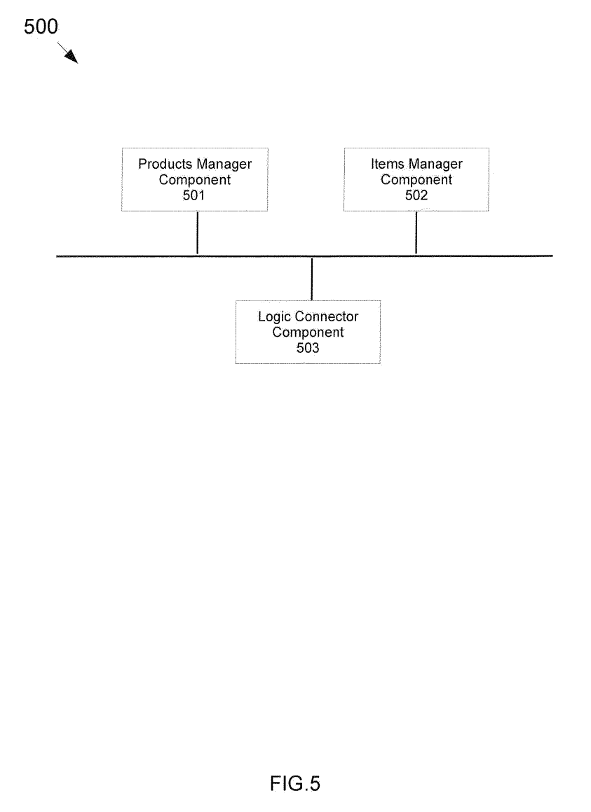

FIG. 5 shows Catalog module 500. Catalog module 500 links to the Suppliers/stock database 204. It controls the users 101 shared items 105, the supplier 125 and products 130. It creates the logic connection between a shared item 105 and a purchasable product 130.

The Catalog module 500 consists of various components that control items 105 and products 130 in the system. Catalog module 500 includes a Products Manager component 501, an Items Manager 502 and a Logic Connector Component 503.

The Products Manager Component 501 controls all actions related to products 130 in the system. It controls all purchasable products 130 of the supplier 125 and interacts with the Suppliers/Stock Database 204. When a new product 130 is ready to be added and/or updated in the system for purchase, the Products Manager Component 501 handles that action. The Products Manager Component 501 collects all relevant information about the product 130 and stores the data in the Suppliers/Stock Database 204 and the activity is logged in the Activity/Statistics database 203.

Items Manager Component 502 controls all actions related to shared items 105 in the system. It controls all items 105 of users 101 and interacts with the Members Database 201. When information relating to a new item 105 is ready to be added for sharing on the system, the Items Manager Component 502 controls its insertion into the system. Items Manager Module 502 collects all relevant information relating to the item 105 and stores the data in the Members Database 201. The activity is logged in the Activity/Statistics database 203.

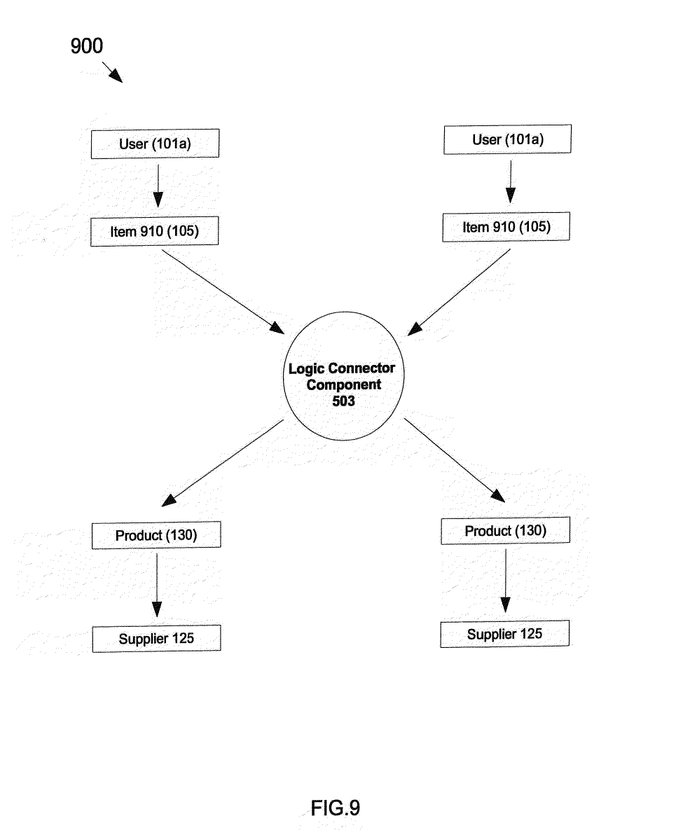

The Logic Connector Component 503 is described below in conjunction with FIG. 9.

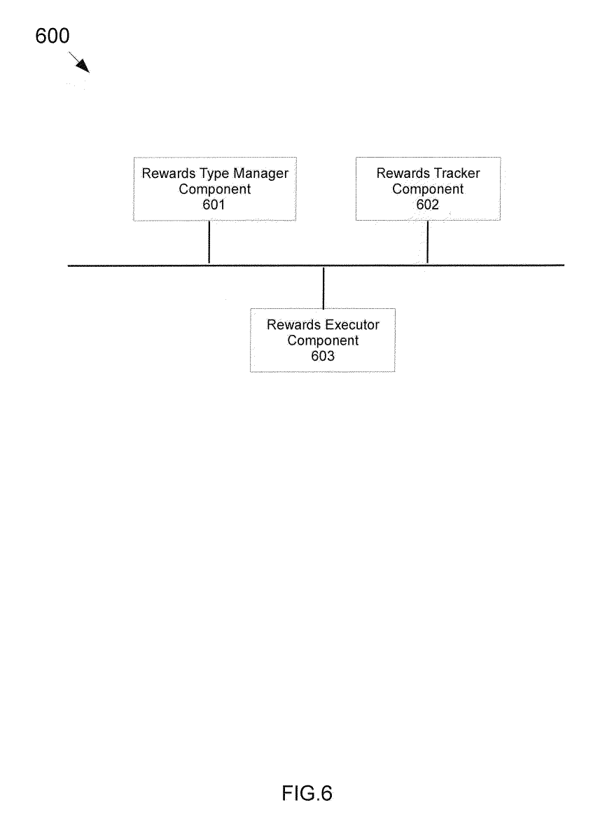

FIG. 6 shows Rewards module 600. Rewards module 600 controls all rewards that users 101 receive when performing certain actions in the system. Rewards module 600 includes a Rewards Type Manager component 601, a Rewards Type Tracker component 602 and a Rewards Executor component 603.

Users will receive rewards on most actions performed in the system which were logged in the Activity/Statistics database 203. Users receive rewards for sharing items on the system, whether or not the shared items are purchased through the system, and for the purchasing items through the system. Those rewards may take the form of monetary awards.

However, the rewards may also include “ranking points” provided with or without monetary awards. Ranking points offer a unique method of achieving higher exposure for shared items in the system. When user 101a shares an item 105, he or she may be rewarded with special ranking points. When user 101b conducts a search for an item, the search results will be returned in accordance with number of the ranking points possessed by the sharing user 101a. Thus, items 105 will be listed in an order determined by how many ranking points the sharing user has been previously awarded, providing an incentive for users to share more items.

When user 101b purchases the product 130 linked to the shared item 105 via Logic Connector Component 503, both the sharing user 101a and the purchasing user 101b are rewarded. In other words, the sharing user 101a is rewarded a second time, this time for having a shared item 105 that was purchased by a user 101b. User 101a will receive money and/or any other reward along with special ranking points. As well, user 101b is rewarded special ranking points for purchasing product 130. Because of the ranking points, users 101a and 101b now have a higher chance of exposing their items on the system, and thus earning additional rewards for participating in the system.

The Rewards Type Manager component 601 manages the different types of rewards available in the system. All definitions related to each reward are handled by Rewards Type Manager component 601. That includes, but is not limited to: the reward name, the reward type (e.g. money, discount, coupons, special ranking points), a thank you note, virtual money, actions necessary for receiving the reward (e.g. product received by the customer, return period of product expires, sharing of an item was successfully completed), the value of the reward (e.g. money: $100, 50 ranking points) and the like. It also determines when the reward should be granted (e.g. executed). All rewards data is stored in the Rewards Database 208.

Rewards Tracker component 602 tracks activities from the Statistics/activity database 203 for which a user 101 should be rewarded. Once the Rewards Tracker component 602 identifies an action for which a user 101 should be rewarded, it stores this data in the Rewards Database 208.

Rewards Executor component 603 executes the rewards. For example: when user 101b purchases a product 130 that was shared as an item 105 of user 101a, both sharing user 101a and purchasing user 101b should be rewarded. However, the award is not granted immediately when the transaction is initiated. It is not to be granted until the transaction is completed, that is, when the defined product return period has passed.

When an action is conducted, the Rewards Tracker component 602 will identify and log the reward in the Rewards Database 208, indicating that the reward should be granted at a date or period of time defined by the Rewards Type Manager component 601. When that date arrives, the Rewards Executor component 603 will grant the reward automatically.

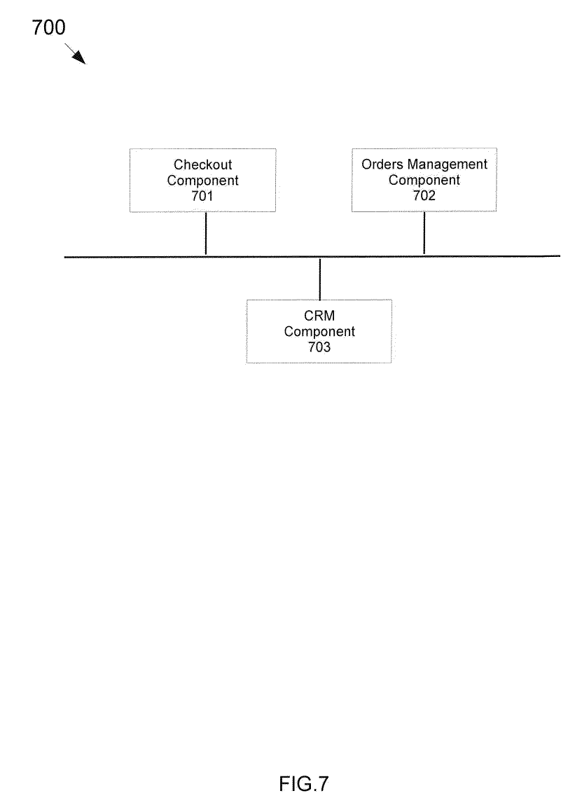

Orders module 700 is shown in FIG. 7. Orders Module 700 controls all users 101 orders and stores the data in the Orders database 202. Orders module 700 includes a Checkout component 701, an Orders Management component 702 and a CRM (Customers Relations Management) component 703.

The Checkout component 701 is a code script in which users 101 conduct a purchase. This is a highly secured component that collects the user's payment information, confirms the payment information, and collects the actual payment via a payment gateway provider. The platform provider 120 may use the Checkout component 701 to redirect a user 101 to the supplier 130 for the compilation of the checkout process. The Checkout component 701 stores all related data in the Orders database 202. The activity is logged in the Activity/Statistics database 203.

Orders Management component 702 controls all actions upon completing a payment by the Checkout component 701, such as alerting the Sales & Support Team 206 of the new order, reserving the purchased product, issuing a shipping request to the shipping provider, receiving a shipping number from the shipping provider. That is, it handles all actions and correspondence relating to the order.

CRM (Customers Relations Management) component 703 handles all correspondence between users 101 and the Sales & Support Team 206. The CRM component 703 includes an interface for the customer 101b which allows both accurate tracking the current status of each order, and correspondence with the Sales & Support Team 206 in any matter or question related to the order.

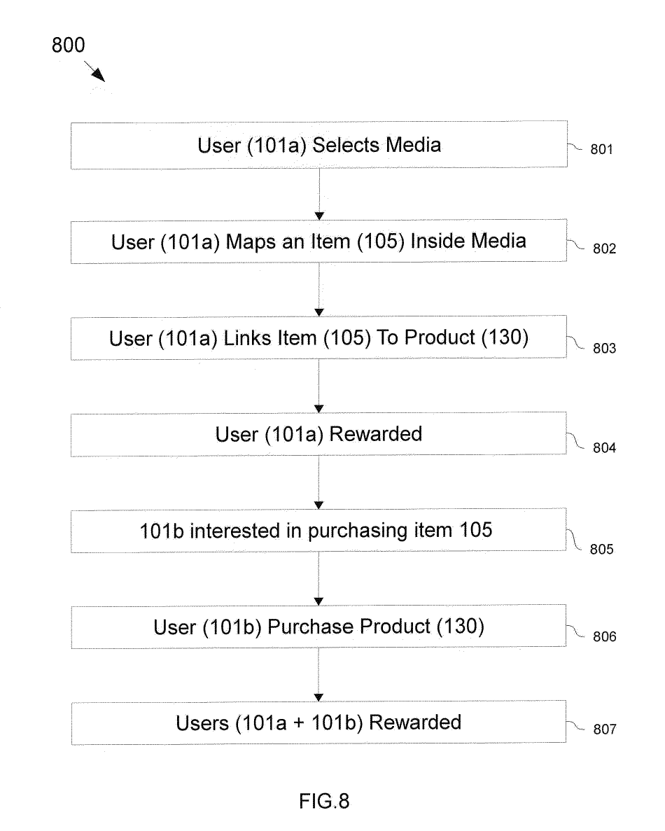

FIG. 8 is a flow diagram of the core method of the present invention. At step 801, user 101a selects a digital media using the Digital Media Select Component 401 via a user device 110 connected to an Interface 205 through the network. User 101a may edit the digital media using the Digital Media Edit component 402. At step 802, user 101a maps an item inside the digital media using the Digital Media Map component 403. Once the digital media is mapped, an item 105 to be shared is created by the Items Manager component 502 and the item 105 is stored in the Members database 201.

At step 803, user 101a links the item 105 (mapped in step 802) to a purchasable product 130 similar to or identical to item 105 via Logic Connector component 503. At step 804, user 101a is rewarded by the Rewards module 600.

At step 805, user 101b interested in purchasing a product similar to or identical to item 105 which is mapped by Digital Media Map Component 403 in a digital media decides to purchase the item 105. The user is forwarded to the linked Logic Connector Component 503 product 130 from supplier 125. At step 806, user 101b purchases the product 130 via the Orders module 700. At step 807, users 101a and 101b are rewarded by the Rewards Module 600.

FIG. 9 shows the Logic Connector component. The Logic Connector Component 503 creates a link connecting a shared item 105 and a similar or identical product corresponding to shared item 105 available for purchase from the stock of purchasable products 130. When a user 101a shares an item 105, this item is connected to a purchasable product 130 via the Logic Connector Component 503. Thus, when user 101b is interested in purchasing a shared item 105 of user 101a, the user 101b is forwarded to a purchasable product 130. When multiple users 101a share the same item (for example, a particular shoe from a particular manufacturer) and multiple suppliers 125 offer the same product, the logic connector will identify that those items 105 and products 130 in fact represent the same purchasable product 130. The Logic Connector Component 503 interacts with the Members database 201 and the Suppliers/stock database 204. Once establishing a connection between an item 105 and a product 130, the Logic Connector component will store the connection data in the system.

It will now be appreciated that the present invention relates to an online system and method for sharing product information, purchasing products and rewarding participants. The system utilizes an Internet social network. The system operates through a computer platform connected to the network. A first user can provide product information to the platform through the network by means connected to the network. A second user may access the platform through the network and view the product information provided by the first user, by means connected to the network. The first user is rewarded for providing the product information. Both the first user and the second user are rewarded, if the second user purchases the product using the system.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims:

I claim:

1. An online system for use with an internet social network, said system comprising:
a computer platform connected to the network, means connected to the network by which a first user can provide information about an item through the network to said platform; means for determining if a similar or identical product corresponding to the item is available for purchase through the system, means connected to said network by which a second user may access said platform through the network, view the information provided by said first user, and purchase the available product; means for rewarding said first user for providing the information, and means for rewarding said first user and said second user, if said second user purchases the product using said system.

2. The system of claim 1 further comprising means connected to said platform for storing information about products available for purchase.

3. The system of claim 1 further comprising means for causing the purchased product to be shipped to said second user.

4. The system of claim 1 wherein said platform comprises means for storing information with respect to registered system users, purchase orders, products available for purchase, and rewards.

5. The system of claim 1 wherein said platform comprises means for storing information about system activity.

6. The system of claim 1 wherein said platform comprises a website accessible by system users.

7. The system of claim 1 wherein said platform comprises means for sales and support personnel to communicate with system users.

8. The system of claim 1 wherein said platform comprises means for registering system users, for creating user accounts and for allowing registered users to log into the system.

9. The system of claim 8 wherein said platform comprises means for allowing registered users to alter the personal information in their accounts.

10. The system of claim 8 wherein said platform comprises means for controlling access to the personal information in the register user accounts.

11. The system of claim 1 wherein said platform comprises means for controlling the digital media in the system.

12. The system of claim 8 wherein said platform comprises means for allowing a registered user to select the digital media for display of an item.

13. The system of claim 12 wherein said platforms comprises means for allowing a registered user to edit the selected digital media.

14. The system of claim 12 wherein said platform comprises means for allowing a registered user to select and label certain regions within the selected digital media.

15. The system of claim 1 further comprising means for storing information about products available for purchase and wherein said platform comprises means for linking said information about products available for purchase and the information about an item provided by said first user.

16. The system of claim 1 wherein said platform comprises means for collecting and storing information relating to products available for purchase.

17. The system of claim 1 wherein said platform comprises means for collecting and storing information about an item provided by said first user.

18. The system of claim 1 wherein said platform comprises means for controlling rewards provided to said first user and to said second user.

19. The system of claim 18 wherein said rewards comprise monetary awards.

20. The system of claim 18 further comprising means for displaying the information about an item provided by said first user in an order determined by the number of ranking points possessed by said first user, and wherein said rewards comprise ranking points.

21. The system of claim 1 further comprising means for tracking activities for which users are entitled to be rewarded.

22. The system of claim 1 further comprising means for controlling the distribution of rewards to users.

23. The system of claim 1 further comprising means for controlling the timing of the distribution of rewards to users.

24. The system of claim 1 further comprising for controlling orders for products received from said second user.

25. The system of claim 1 further comprising means for controlling payments for orders for products received from said second user.

26. The system of claim 1 further comprising means for requesting and monitoring the status of shipment of orders for products received from said second user.

27. The system of claim 1 wherein said means connected to the network by which a first user can provide information about an item through the network to the platform comprise a mobile phone.

28. The system of claim 1 wherein the means connected to the network by which a second user may access the platform through the network, view the information provided by the first user and purchase the available product comprise a mobile phone.

29. An online method using an Internet social network and a computer platform connected to the network; the method comprising the steps of:
providing information about an item to the platform through the network by a first user connected to the network;
determining if a similar or identical product corresponding to the item is available for purchase through the platform;
accessing the platform through the network by a second user connected to the network to view the information about the item provided by the first user;
rewarding the first user for providing the information about the item; and
rewarding the first user and the second user, if the second user purchases the product using the platform.

30. The method of claim 29 further comprising the step of storing information about products available for purchase.

31. The method of claim 29 further comprising the step of causing the purchased product to be shipped to the second user.

32. The method of claim 29 further comprising the step of storing information with respect to registered system users, purchase orders, products available for purchase, and rewards.

33. The method of claim 29 further comprising the step of storing information about system activity.

34. The method of claim 29 further comprising the step of accessing a website by system users.

35. The method of claim 29 further comprising the step of sales and support personnel communicating with registered system users.

36. The method of claim 29 further comprising the steps of registering system users, creating user accounts and allowing registered users to log into the system.

37. The method of claim 29 further comprising the step of allowing registered users to alter the personal information in their accounts.

38. The method of claim 29 further comprising the step of controlling access to the personal information in the register user accounts.

39. The method of claim 29 further comprising the step of controlling the digital media in the system.

40. The method of claim 29 further comprising the step of allowing a registered user to select the digital media for display of the item about which information was provided.

41. The method of claim 40 further comprising the step of allowing a registered user to edit the selected digital media.

42. The method of claim 41 further comprising the step of allowing a registered user to select and label certain regions within the selected digital media.

43. The method of claim 29 further comprising the steps of storing information about products available for purchase and linking the information about products available for purchase and the item about which information was provided by the first user.

44. The method of claim 29 further comprising the steps of collecting and storing information relating to products available for purchase.

45. The method of claim 29 further comprising the steps of collecting and storing information about the item provided by the first user.

46. The method of claim 29 further comprising the step of controlling the rewards provided to the first user and the second user.

47. The method of claim 29 further comprising the step of providing rewards in the form of monetary awards.

48. The method of claim 29 further comprising the steps of providing rewards in the form of ranking points and displaying the item about which information was provided by the first user in an order determined by the number of ranking points possessed by the first user.

49. The method of claim 29 further comprising the step of tracking activities for which users are entitled to be rewarded.

50. The method of claim 29 further comprising the step of controlling the distribution of rewards to users.

51. The method of claim 29 further comprising the step of controlling the timing of the distribution of rewards to users.

52. The method of claim 29 further comprising the step of controlling orders for products received from the second user.

53. The method of claim 29 further comprising the step of controlling payments for orders for products received from the second user.

54. The method of claim 29 further comprising the steps of requesting and monitoring the status of shipment of orders for products received from the second user.

55. The system of claim 29 wherein the step of providing information about an item to the platform through the network by a first user connected to the network comprises the step of providing information about an item to the platform through the network by a first user connected to the network using a mobile phone.

56. The system of claim 29 wherein the step of accessing the platform through the network by a second user connected to the network to view the information about the item provided by the first user comprises accessing the platform through the network by a second user connected to the network to view the information about the item provided by the first user using a mobile phone.
